(19) United States
(12) Patent Application Publication
(10) Pub. No.: US 2024/0289309 A1
(43) Pub. Date: Aug. 29, 2024

(54) ERROR DEDUPLICATION AND REPORTING FOR A DATA MANAGEMENT SYSTEM BASED ON NATURAL LANGUAGE PROCESSING OF ERROR MESSAGES

(71) Applicant: Rubrik, Inc., Palo Alto, CA (US)

(72) Inventors: Abhishek Kumar, Ellenabad (IN); Sriramulu Lakkaraju, San Jose, CA (US); Prabudas Varadarajan, Bangalore (IN)

(21) Appl. No.: 18/115,758

(22) Filed: Feb. 28, 2023

(51) Int. Cl. G06F 16/215; G06F 3/04847; G06F 40/20; G06F 40/40

(52) U.S. Cl. CPC G06F 16/215; G06F 3/04847; G06F 40/20; G06F 40/40

(57) ABSTRACT

Methods, systems, and devices for data management are described. A data management system (DMS) may generate or receive error logs when a backup process fails. To more easily analyze and compare error logs, the error logs may be processed by a natural language processing (NLP) program. The NLP program extracts, from an individual error log, a natural language string for the error message and metadata associated with the error. The processed error logs may be stored in a database as a natural language string for the error message and metadata extracted from the error log by the NLP program. The NLP program may simplify the string by removing items such as punctuation, defined stop words, geographic terms, uniform resource locators, gerunds, and tenses, may tokenize the string, and extract metadata type information. Comparison and analysis may more easily be performed on the natural language error strings and accompanying metadata.

### FIELD OF TECHNOLOGY

The present disclosure relates generally to data management, including techniques for error deduplication and reporting for a data management system based on natural language processing of error messages.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports error deduplication and reporting for a data management system (DMS) based on natural language processing (NLP) of error messages in accordance with aspects of the present disclosure.

FIG. 2 illustrates an example of an error processing system that supports error deduplication and reporting for a DMS based on NLP of error messages in accordance with aspects of the present disclosure.

FIG. 3 illustrates an example of a user interface view that supports error deduplication and reporting for a DMS based on NLP of error messages in accordance with aspects of the present disclosure.

FIG. 4 illustrates an example of a process flow that supports error deduplication and reporting for a DMS based on NLP of error messages in accordance with aspects of the present disclosure.

FIG. 5 illustrates a block diagram of an apparatus that supports error deduplication and reporting for a DMS based on NLP of error messages in accordance with aspects of the present disclosure.

FIG. 6 illustrates a block diagram of a DMS that supports error deduplication and reporting for a DMS based on NLP of error messages in accordance with aspects of the present disclosure.

FIG. 7 illustrates a diagram of a system including a device that supports error deduplication and reporting for a DMS based on NLP of error messages in accordance with aspects of the present disclosure.

FIGS. 8 through 10 illustrate flowcharts showing methods that support error deduplication and reporting for a DMS based on NLP of error messages in accordance with aspects of the present disclosure.

### DETAILED DESCRIPTION

A data management system (DMS) may obtain and store snapshots of computing objects (e.g., computing resources) for one or more customers or clients. The DMS may receive error logs when a backup process fails, for example due to failures at cloud providers or third party providers. In accordance with a service level agreement (SLA), a backup operation may be attempted at regular intervals, and accordingly a failed backup operation may continue to fail until the root problem is corrected. Additionally, a same root error (e.g., an error on a given pod) may propagate across customers or accounts. Across the DMS, the quantity of error logs may be high and repetitive due to repetitive and/or propagated failures. Due to the punctuation and insertion of stop words such as the account name, customer identifier (ID), pod name, etc., error log strings that indicate the same root error may be difficult to directly compare. Further, error logs provided by different cloud providers or third party providers may be formatted differently, and thus also may be difficult to compare. Accordingly, error alerts may be repetitive, and analysis of errors may be difficult due to the difficulty of identifying which error logs represent the same error.

To more easily analyze and compare error logs, the error logs may be processed by a natural language processing (NLP) program. The NLP program extracts, from an individual error log, a natural language string for the error message and metadata associated with the error (e.g., account, timestamp, pod ID, etc.). The DMS may collect error logs (e.g., across multiple customers or accounts) in a first database. The NLP program may periodically run on new error logs (e.g., the NLP program may run every hour on the new error logs collected in the last hour). The processed error logs may be stored in a second database as a natural language string for the error message and metadata extracted from the error log by the NLP program. The NLP program may remove punctuation, remove defined stop words, remove geographic terms (e.g., region, country name, availability zone), remove uniform resource locators (URLs), tokenize the string of the error log, remove and extract metadata type information (e.g., account, timestamp, pod ID, etc.), and simplify the string (e.g., removing gerunds, tenses, etc.). Comparison and analysis may more easily be performed on the natural language error strings and accompanying metadata. For example, daily reports may be provided showing the frequency of given errors and accounts/customers affected. Additionally, deduplication of the errors may be performed using the natural language error strings before alerts are sent, thereby reducing repetitive alerts.

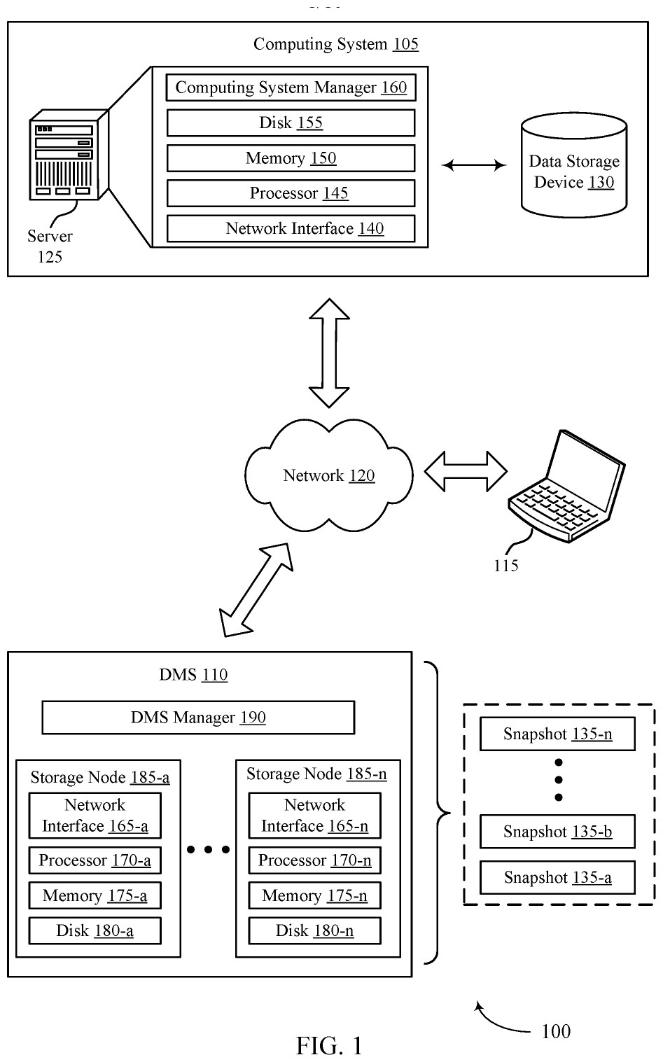

FIG. 1 illustrates an example of a computing environment 100 that supports error deduplication and reporting for a DMS based on NLP of error messages in accordance with aspects of the present disclosure. The computing environment 100 may include a computing system 105, a DMS 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory ((ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described herein.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state-which may be referred to as the delta-of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

The DMS 110 may receive or generate error logs when a backup process fails. For example, a backup process may fail when the DMS 110 fails to generate a snapshot 135 of a target computing object, when malware is detected, when backup verification fails, when underlying data is corrupted, or when a storage node 185 fails. As another example, an error log may be received from cloud providers or third party providers that store backup data (e.g., a storage node 185 may be provided by a cloud provider or third party provider). As the DMS 110 may attempt backup operations at regular intervals, a failed backup operation may continue to fail until the root problem is resolved, and accordingly multiple error logs may be generated for the same error for each backup attempt. A same root error (e.g., an error on a given pod) may also propagate across customers or accounts. Across the DMS 110, the quantity of error logs may be high and repetitive due to repetitive or propagated failures. Due to the punctuation and insertion of stop words such as the account name, customer ID, pod name, etc., error log strings that indicate the same root error may be difficult to directly compare. Further, error logs provided by different cloud providers or third party providers may be formatted differently, and thus also may be difficult to compare. Accordingly, error alerts may be repetitive, and analysis of errors may be difficult due to the difficulty of identifying which error logs represent the same error.

To more easily analyze and compare error logs, the error logs may be processed by an NLP program, which may be run by the DMS 110 or at a cloud location. The NLP program extracts, from an individual error log, a natural language string for the error message and metadata associated with the error (e.g., account, timestamp, pod ID, etc.). The DMS 110 may collect error logs (e.g., across multiple customers or accounts) in a first database (e.g., at the network 120 or locally at the DMS 110). The NLP program may periodically run on new error logs (e.g., the NLP program may run every hour on the new error logs collected in the last hour). The processed error logs may be stored in a second database (e.g., at the network 120 or locally at the DMS 110) as a natural language string for the error message and metadata extracted from the error log by the NLP program. The NLP program may remove punctuation, remove defined stop words, remove geographic terms (e.g., region, country name, availability zone), remove URLs, tokenize the string of the error log, remove and extract metadata type information (e.g., account, timestamp, pod ID, etc.), and simplify the string (e.g., removing gerunds, tenses, etc.). Comparison and analysis may more easily be performed on the natural language error strings and accompanying metadata. For example, daily reports may be provided showing the frequency of given errors and accounts/customers affected. Daily reports may be viewed by an administrator of the DMS 110, for example, via a user interface view presented at the computing device 115. Additionally, deduplication of the errors may be performed using the natural language error strings before alerts are sent, thereby reducing repetitive alerts. Error alerts may be sent to a computing device 115 associated with an administrator of the DMS 115.

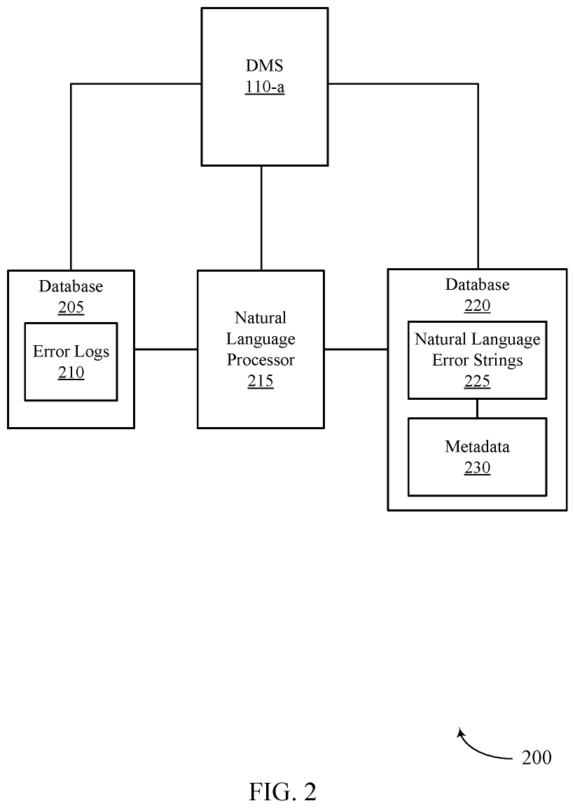

FIG. 2 illustrates an example of an error processing system 200 that supports error deduplication and reporting for a DMS based on NLP of error messages in accordance with aspects of the present disclosure. The error processing system 200 may implement or be implemented by aspects of the computing environment 100 described with reference to FIG. 1. For example, a DMS 110-a may be an example of a DMS 110 as described herein.

The DMS 110-a may receive or generate error logs when a backup process fails. The DMS 110 may collect error logs 210 (e.g., across multiple customers or accounts) in a first database 205. As the DMS 110-a may attempt backup operations at regular intervals, a failed backup operation may continue to fail until the root problem is resolved, and accordingly multiple error logs may be generated for the same error for each backup attempt. A same root error (e.g., an error on a given pod) may also propagate across customers or accounts. Across the DMS 110-a, the quantity of error logs may be high and repetitive due to repetitive and/or propagated failures. Due to the punctuation and insertion of stop words such as the account name, customer id, condition message, pod effected, etc., error log strings that indicate the same root error may be difficult to directly compare. For example, Table 1 shows two error log messages that have the same root error but look different due to stop words, punctuation, and URLs in the strings.

TABLE 1

| Error String 1 | Error String 2 |
|---|---|
| failed to backup: create pod error: Wait for | failed to backup: create pod error: Wait for |
| RBA pods failed.: Failed to find pod . . . | RBA pods failed.: Failed to find pod . . . |
| Reason: Pod Name: rbs-rs-30013-f4ff199f- | Reason: Pod Name: xyz-tm-413456-p4gg199v- |
| d6b1-4187-a8af-1dd264a3b74c-4m2nj, | d6ul-9000-v8ty-1pp264a2t14q-7ctpj, |
| Condition message: 0/10 nodes are | Condition message: 3/10 nodes are |
| available: 10 pod has unbound immediate | available: 7 pod has unbound immediate |
| PersistentVolumeClaims. preemption: 0/10 | PersistentVolumeClaims. preemption: 7/10 |
| nodes are available: 10 Preemption is not | nodes are available: 10 Preemption is not |
| helpful for scheduling.;: condition not met yet | helpful for scheduling.;: condition not met yet |

Accordingly, setting up alerts without identifying that the two errors in Table 1 have the same root error may be inefficient, as an administrator of the DMS 110-a may receive two alerts for the same error. Additionally, without identifying that the two errors in Table 1 have the same root error, a periodic (e.g., daily) error report may not identify that the two errors have the same root error, and accordingly the two errors may be reported separately. As another example, error analysis may be difficult without deduplicating error logs (e.g., identifying that the two errors in Table 1 have the same root error). For example, an administrator of the DMS 110-a may query the most frequent errors across the DMS 110-a, but if errors having the same root cause are not identified as such, then such queries may be inaccurate or difficult to process.

An NLP program 215 may periodically run on new error logs 210 (e.g., the NLP program 215 may run every hour on the new error logs 210 collected in the last hour). The processed error logs may be stored in a second database 220 as a natural language error string 225 for the error message and metadata 230 extracted from the error log by the NLP program. The natural language error strings 225 and accompanying extracted metadata 230 may be easier to analyze than error strings in the unprocessed error logs 210.

The NLP program 215 may remove punctuation, remove defined stop words, remove geographic terms (e.g., region, country name, availability zone), remove URLs, remove numerals, tokenize the string of the error log, remove and extract metadata type information (e.g., account, timestamp, pod ID, etc.), may perform lemmatization on the string of the error log, and may simplify the string (e.g., perform stemming, removing gerunds, tenses, etc.). The stop words may be received by the DMS 110-a as a configured list (e.g., from an administrator via a computing device 115 of FIG. 1). For example, stop words may include account names, pod IDs, customer IDs, condition messages, jargon words (words that have no meaning), or the pod affected. For example, the NLP program 215 may intelligently detect and remove identifiers (e.g., based on known IDs such as pod IDs, object IDs, or customer IDs). In some examples, the NLP program 215 may identify redundant information in the same error string and may remove the redundant information. In some examples, the NLP program 215 may identify and remove patterns, such as patterns of repeated words, phrases, or numerals. For example, Table 2 shows examples of original error strings in the error logs 210 and corresponding processed natural language error strings 225 generated by the NLP program 215.

TABLE 2

| Original Error String | Processed Error Form after NLP |
|---|---|
| Finished taskchain with state: Failed, error: | unable create virtual machine snapshot |
| unable to create virtual machine snapshot | unable create managed disk snapshot |
| (unable to create managed disk snapshot (Azure | azure linkedauthorizationfailed client |
| error: [LinkedAuthorizationFailed] The client | object id permission perform action |
| ‘5a05c18e-2050-48ff-bcd9-74fb2c8b9787’ with | microsoftcomputesnapshotswrite scope |
| object id ‘5a05c18e-2050-48ff-bcd9- | however permission perform action |
| 74fb2c8b9787’ has permission to perform action | microsoftcomputedisksbegingetaccessaction |
| ‘Microsoft.Compute/snapshots/write’ on scope | linked scopes linked scopes invalid |
| ‘/subscriptions/4a35f8be-6dae-4d13-b97c- | blocked deny assignments linked scopes |
| 8fb26b100 2f7/resourceGroups/RubrikBackups- | information please visit |
| RG-DontDelete/providers/Microsoft.Compute/ | |
| snapshots/Rubrik-Snapshot-VM-d8fd1182-4750- | |
| 4a65-bc00-df648a1d655d’; however, it does not | |
| have permission to perform action | |
| ‘Microsoft.Compute/disks/beginGetAccess/action’ | |
| on the ‘0’ linked scope(s) ‘’ or the linked | |
| scope(s) are invalid and is blocked by deny | |
| assignments on the ‘1’ linked scope(s) | |
| ‘/subscriptions/4a35f8be-6dae-4d13-b97c- | |
| 8fb26b100 2f7/resourceGroups/databricks-rg- | |
| dbr-entdata-prod-eastus-001-ngzbv7oszqs7k/ | |
| providers/Microsoft.Compute/disks/ | |
| d4914625738740a295204e9d2380de5e- | |
| 0-scratch Volume’.). For more information | |
| on this error, please visit | |
| https://support.rubrik.com/s/article/000004951) | |
| Finished taskchain with state: Failed, error: no | os disk attached virtual machine |
| OS disk is attached to the virtual machine | |
| Finished taskchain with state: Failed, error: | os disk attached virtual machine |
| error making CDM request to | |
| 100.80.0.99:30000:0/k8squery/v1/api/v1/namespace? | |
| options = %7B %7D: (504) 504 Gateway Timeout | |

The processed error forms after NLP may be more easily compared in order for the DMS 110-a to determine whether two error messages are the same, and error reporting and alerting may be performed after deduplicating error messages (e.g., accounting for error messages that are the same). For example, as shown in Table 2, the second and third error logs in Table 2 have the same processed error form after the NLP program 215 is run on the original error strings. For example, the DMS 110-a may identify two errors in the error logs 210 are the same if the natural language error strings 225 have a similarity that exceeds a threshold (e.g., if 90% of the characters of the natural language error strings 225 are the same).

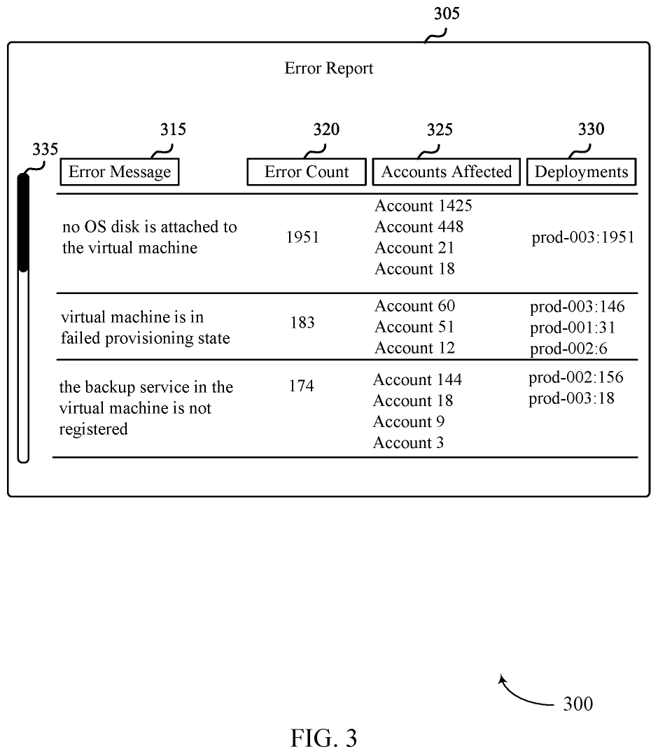

An example of a record in the second database 220 may be {“error”: “Finished taskchain with state: Failed, error: taskchain crashed previously”, “processed_error”: “crashed previously”, “account”: “manutan”, “taskchain_id”: “47cb6a15-e6f1-407f-b8e5-f09be4b99cbd”, “timestamp”: “2022-11-18T02: 10:16.391000”, “job_type”: “korg-job-gps-data-ingestion”, “deployment”: “prod-002”, “component”: “gps”, “is_user_visible_error”: “NA for this log”, “error_code”: “NA for this log”, “invocation_id”: “2022-11-18T03:00:00”}, where the “error” field includes the natural language error string, and the remaining fields are metadata 230 extracted from the error string in the error log 210. Accordingly, the DMS 110-a may perform error analysis and reporting based on the error field and the metadata 230 stored in the second database 220. Such analysis may be periodic (e.g., daily, hourly). For example, as described with reference to FIG. 3, the DMS 110-a may generate a daily error report based on the processed error logs (e.g., the natural language error strings 225 and accompanying metadata 230).

Similarly, alerting solutions may be implemented by the DMS 110-a based on the processed error logs (e.g., the natural language error strings 225 and accompanying metadata 230). For example, alerts may be triggered based on error types, periods (e.g., if a particular error occurs during a given period of time), and error thresholds (e.g., if the same error occurs a threshold quantity of times). Processed error messages (e.g., the natural language error strings 225 and accompanying metadata 230) may be compared, and if the error count for a same error exceeds the configured threshold, an incident may be created, and an alert may be sent to an administrator of the DMS 110-a (e.g., to a computing device 115 of the administrator). For example, an administrator may configure an alert to occur if the error message “failed to backup: create pod error: Wait for RBA pods failed: Failed to find pod. Reason: Pod Name: rbs-rs-30013-f4ff199f-d6b1-4187-a8af-1dd264a3b74c-4m2nj, Condition message: 0/10 nodes are available: 10 pod has unbound immediate PersistentVolumeClaims. preemption: 0/10 nodes are available: 10 Preemption is not helpful for scheduling: condition not met yet threshold: 20 period: hourly,” or a same error identified by the NLP program 215 occurs a threshold quantity of times (e.g., 20 times) within a threshold period of time (e.g., an hour). For example, the administrator may provide the unprocessed error message “failed to backup: create pod error: Wait for RBA pods failed: Failed to find pod. Reason: Pod Name: rbs-rs-30013-f4ff199f-d6b1-4187-a8af-1dd264a3b74c-4m2nj, Condition message: 0/10 nodes are available: 10 pod has unbound immediate PersistentVolumeClaims. preemption: 0)/10 nodes are available: 10 Preemption is not helpful for scheduling: condition not met yet threshold: 20 period: hourly,” to the DMS 110-a in order to receive alerts when the same error occurs the threshold quantity of times within the defined period.

The NLP program 215 may process the received unprocessed error message and convert the error message to a processed natural language error string 225 and accompanying metadata. Then the DMS 110-a may query the natural language error strings 225 in the second database 220 to find natural language error strings that match the processed natural language error string 225 of the error message provided by the administrator. The DMS 110-a may create an alert incident if the error count reaches the administrator defined threshold within the period. A processing layer may run the NLP program 215, and an output layer may handle incident creation, ensure that a duplicate alert is not created for a same incident/error (unless the same incident/error had been resolved previously), and store created alerts and checked stored alerts before creating new alerts.

FIG. 3 illustrates an example of a user interface view 300 that supports error deduplication and reporting for a DMS based on NLP of error messages in accordance with aspects of the present disclosure. The user interface view 300 may implement or be implemented by aspects of the computing environment 100 described with reference to FIG. 1. For example, the user interface view 300 may be presented at a computing device 115 as described with reference to FIG. 1.

A DMS 110 may generate a periodic (e.g., daily) error report 305 based on NLP of error logs as described herein. The error report may be presented in a user interface view 300, for example, at a computing device 115 of an administrator of the DMS 110. The error report 305 may include a first column 315 showing the natural language error string (e.g., the natural language error string 225) generated by the NLP program 215 of FIG. 2. A second column 320 may show the quantity of times each error was detected during the period, for example based on a comparison of the natural language error strings 225 to identify same errors. A third column 325 may show the accounts (e.g., customer accounts) affected by the error. The customer accounts may be identified based on the metadata 230 extracted from the error logs 210 by the NLP program 215. A fourth column 330 may show the deployments (e.g., pods, or storage nodes 185) affected by the error, for example, based on the metadata 230 extracted from the error logs 210 by the NLP program 215. A scroll element 335 may enable the administrator to scroll through the errors identified in the error report.

By providing a natural language presentation of each error, the quantities that each error occurred, the accounts affected, and the deployments affected, an administrator may identify the most important and/or frequent errors. Accordingly, an administrator may prioritize the errors based on such information, and resolve the errors based on the prioritization.

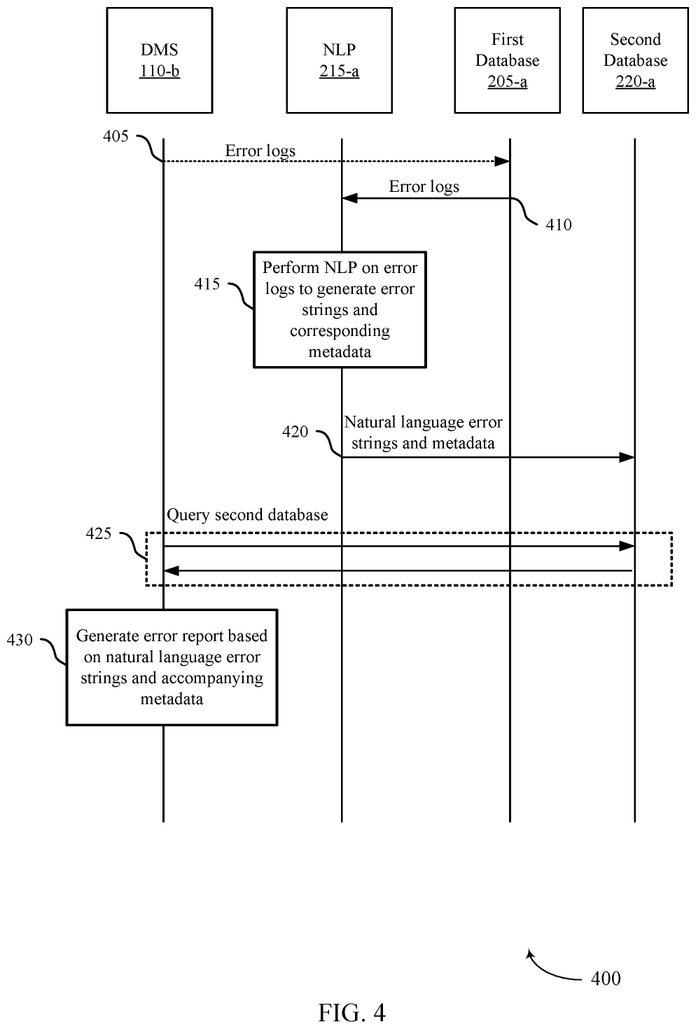

FIG. 4 illustrates an example of a process flow 400 that supports error deduplication and reporting for a DMS based on NLP of error messages in accordance with aspects of the present disclosure. The process flow 400 may include a DMS 110-b, which may be an example of a DMS 110 as described herein. The process flow 400 may include an NLP program 215-a, which may be an example of an NLP program 215 as described herein. For example, the NLP program 215-a may be a program run locally at the DMS 110-a or on a cloud computing service. The process flow 400 may include a first database 205-a and a second database 220-a, which may be examples of a first database 205 and a second database 220 as described herein. In some examples, the first database 205-a and the second database 220-a may be a same database (e.g., located at a same storage location). In the following description of the process flow 400, the operations between the DMS 110-b, the NLP program 215-a, the first database, 205-a, and the second database 220-a may be transmitted in a different order than the example order shown, or the operations performed by the DMS 110-b, the NLP program 215-a, the first database, 205-a, and the second database 220-a may be performed in different orders or at different times. Some operations may also be omitted from the process flow 400, and other operations may be added to the process flow 400.

In some examples, at 405, the DMS 110-b may store error logs for backup operations controlled by the DMS 110-b in the first database 205-a. For example, the error logs may be generated by the DMS 110-b or may be received from third party providers (e.g., storage location providers such as cloud providers).

At 410, the NLP program 215-a may receive a set of error logs from the first database 205-a. For example, the NLP program 215-a may periodically (e.g., every hour) receive the error logs from the first database 205-a.

At 415, the NLP program 215-a may perform NLP on the received set of error logs to generate a set of natural language error strings and corresponding metadata for the set of error logs. In some examples, performing the NLP may include removing punctuation in error strings of the set of error logs, removing stop words in the error strings of the set of error logs, removing numerals in error strings of the set of error logs, removing URLs in the error strings of the set of error logs, removing geographic information in the error strings of the set of error logs, performing tokenization on the error strings of the set of error logs, performing stemming on the error strings of the set of error logs, performing lemmatization on the error strings of the set of error logs, or a combination thereof. In some examples, the stop words may be configured by an administrator of the DMS 110-b (e.g., the DMS 110-b may receive an indication of the trop words from a user interface view associated with the administrator of the DMS 110-b).

At 420, the NLP program 215-a may store the set of natural language error strings and corresponding metadata for the set of error logs in the second database 220-a.

At 430, the DMS 110-b may generate an error report based on the set of natural language error strings and corresponding metadata stored in the second database 220-a, where the error report identifies one or more same errors associated with the set of error logs based on the set of natural language error strings. For example, at 425, the DMS 110-a may access the natural language error strings and corresponding metadata stored at the second database 220-a.

In some examples, the error report may identify a set of unique errors associated with the set of error logs, where a same error in two or more error logs of the set of error logs is a single unique error. In some examples, the error report may identify or indicate the quantity of instances each unique error occurred in the set of error logs.

In some examples, the DMS 110-b may identify that two or more natural language error strings correspond to a same error based on the two or more natural language error strings having a character similarity satisfying a threshold. For example, the DMS 110-b may identify that two or more natural language error strings correspond to a same error if a threshold quantity of the characters of the error strings are the same (e.g., 90%). As another example, the DMS 110-b may perform a partial matching function on two natural language error strings. A partial matching function may take the shortest string from one natural language error string and match the shortest substring with all substrings that are of the same length in the other natural language error string. If the output of the partial matching function for two natural language strings is more than a threshold, the natural language error strings may be identified as corresponding to the same error.

In some examples, the DMS 110-b may periodically generate error reports. For example, at 430, the DMS 110-b may generate the error report based on a duration since the last error report generated by the DMS 110-b. In some examples, an administrator may configure the periodicity of error reports (e.g., the DMS 110-b may receive an indication of the duration from a user interface view associated with the administrator of the DMS 110-b). In some examples, the error report may be based on all stored error logs since the last error report. For example, the NLP program 215-a may perform NLP on error logs stored in the first database 205-a at a different periodicity than the error reports are generated, and error reports may be generated based on all error logs stored in the first database 205-a since the last error report.

In some cases, generation of the error report at 230 may be alert or incident based. For example, the error report may be generated based on a quantity of instances of a same error satisfying or exceeding a configured incident threshold. In some examples, an administrator may configure the threshold quantity reports (e.g., the DMS 110-b may receive an indication of the threshold from a user interface view associated with the administrator of the DMS 110-b). In some cases, generation of the error report at 230 may be based on the corresponding metadata satisfying a triggering condition (e.g., a particular account, a particular pod, a particular job type, or a particular customer ID).

In some examples, the error report may be presented at a user interface view associated with an administrator of the DMS 110-b.

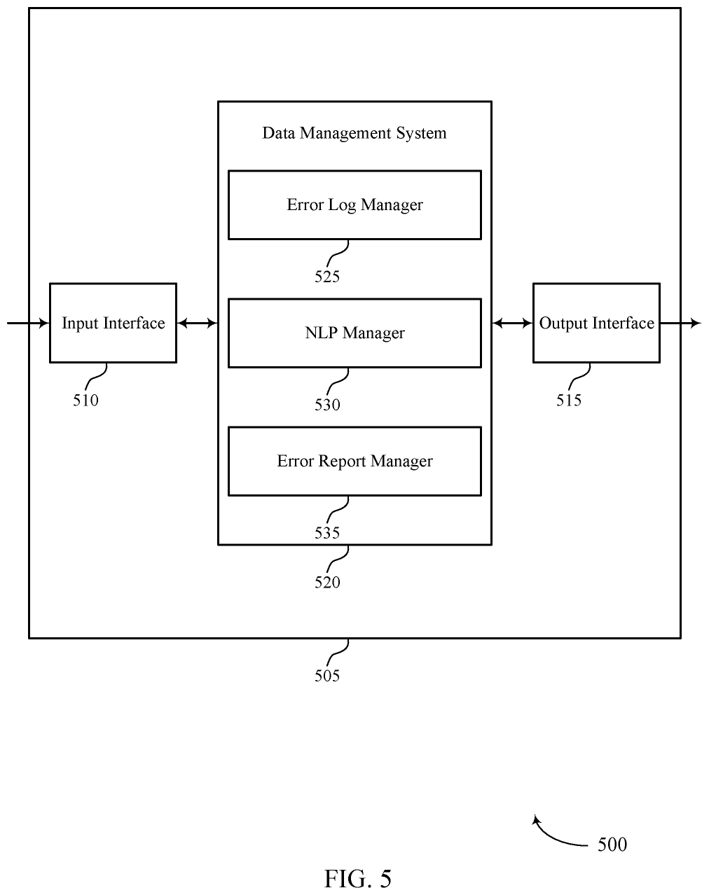

FIG. 5 illustrates a block diagram 500 of a system 505 that supports error deduplication and reporting for a DMS based on NLP of error messages in accordance with aspects of the present disclosure. In some examples, the system 505 may be an example of aspects of one or more components described with reference to FIG. 1, such as a DMS 110. The system 505 may include an input interface 510, an output interface 515, and a DMS 520. The system 505 may also include one or more processors. Each of these components may be in communication with one another (e.g., via one or more buses, communications links, communications interfaces, or any combination thereof).

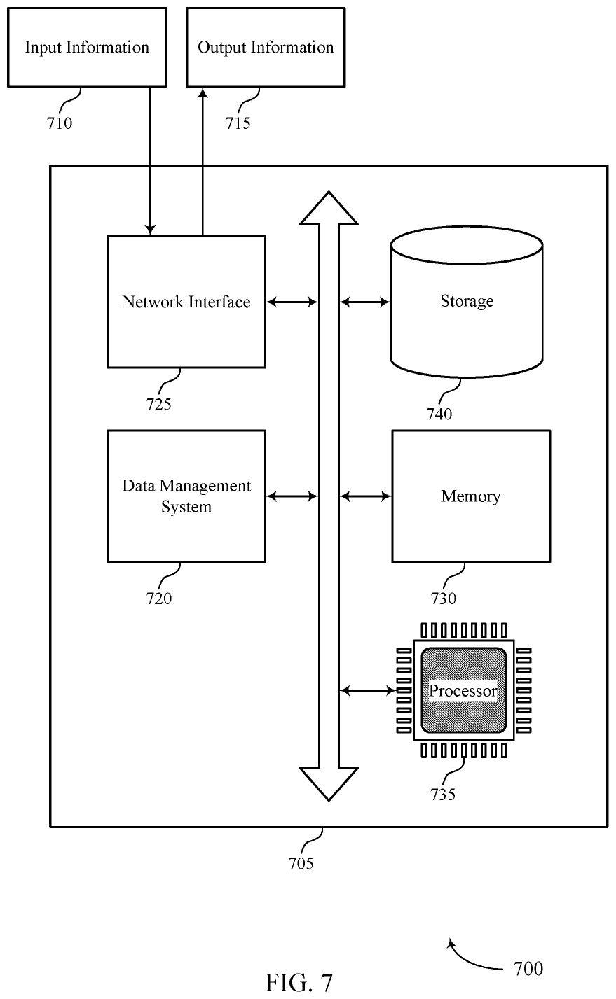

The input interface 510 may manage input signaling for the system 505. For example, the input interface 510 may receive input signaling (e.g., messages, packets, data, instructions, commands, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the DMS 520 to support error deduplication and reporting for a DMS based on NLP of error messages. In some cases, the input interface 510 may be a component of a network interface 725 as described with reference to FIG. 7.

The output interface 515 may manage output signaling for the system 505. For example, the output interface 515 may receive signaling from other components of the system 505, such as the DMS 520, and may transmit such output signaling corresponding to (e.g., representative of or otherwise based on) such signaling to other systems or devices. In some cases, the output interface 515 may be a component of a network interface 725 as described with reference to FIG. 7.

For example, the DMS 520 may include an error log manager 525, an NLP manager 530, an error report manager 535, or any combination thereof. In some examples, the DMS 520, or various components thereof, may be configured to perform various operations (e.g., receiving, monitoring, transmitting) using or otherwise in cooperation with the input interface 510, the output interface 515, or both. For example, the DMS 520 may receive information from the input interface 510, send information to the output interface 515, or be integrated in combination with the input interface 510, the output interface 515, or both to receive information, transmit information, or perform various other operations as described herein.

The error log manager 525 may be configured as or otherwise support a means for receiving, from a first database, a set of error logs associated with a DMS. The NLP manager 530 may be configured as or otherwise support a means for performing NLP on the set of error logs to generate a set of natural language error strings and corresponding metadata for the set of error logs. The NLP manager 530 may be configured as or otherwise support a means for storing the set of natural language error strings and corresponding metadata for the set of error logs in a second database. The error report manager 535 may be configured as or otherwise support a means for generating an error report based on the set of natural language error strings and corresponding metadata stored in the second database, where the error report identifies one or more same errors associated with the set of error logs based on the set of natural language error strings.

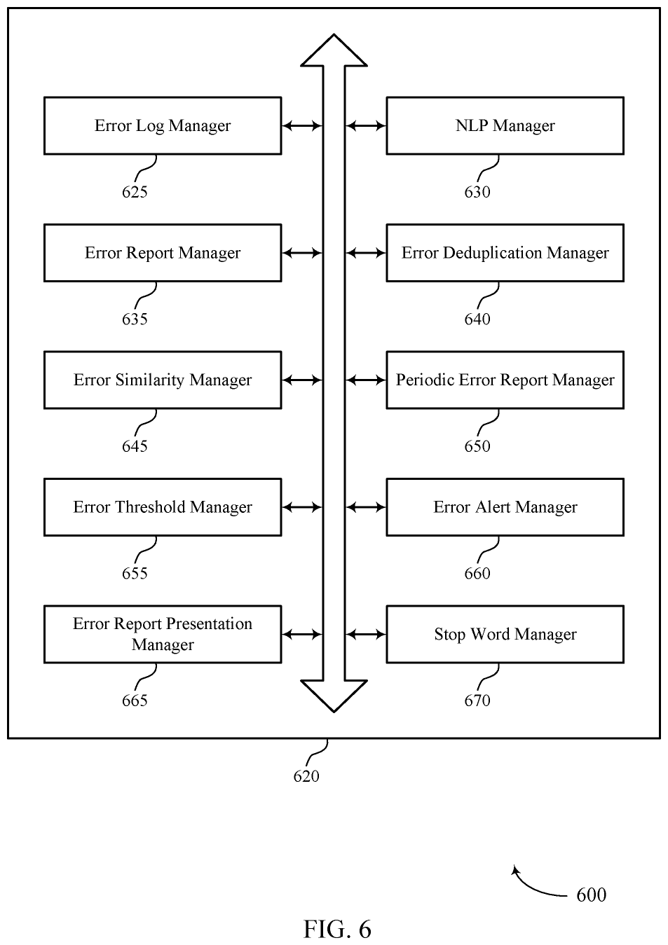

FIG. 6 illustrates a block diagram 600 of a DMS 620 that supports error deduplication and reporting for the DMS based on NLP of error messages in accordance with aspects of the present disclosure. The DMS 620 may be an example of aspects of a DMS or a DMS 520, or both, as described herein. The DMS 620, or various components thereof, may be an example of means for performing various aspects of error deduplication and reporting for the DMS based on NLP of error messages as described herein. For example, the DMS 620 may include an error log manager 625, an NLP manager 630, an error report manager 635, an error deduplication manager 640, an error similarity manager 645, a periodic error report manager 650, an error threshold manager 655, an error alert manager 660, an error report presentation manager 665, a stop word manager 670, or any combination thereof. Each of these components may communicate, directly or indirectly, with one another (e.g., via one or more buses, communications links, communications interfaces, or any combination thereof).

The error log manager 625 may be configured as or otherwise support a means for receiving, from a first database, a set of error logs associated with a DMS. The NLP manager 630 may be configured as or otherwise support a means for performing NLP on the set of error logs to generate a set of natural language error strings and corresponding metadata for the set of error logs. In some examples, the NLP manager 630 may be configured as or otherwise support a means for storing the set of natural language error strings and corresponding metadata for the set of error logs in a second database. The error report manager 635 may be configured as or otherwise support a means for generating an error report based on the set of natural language error strings and corresponding metadata stored in the second database, where the error report identifies one or more same errors associated with the set of error logs based on the set of natural language error strings.

In some examples, to support generating the error report, the error deduplication manager 640 may be configured as or otherwise support a means for generating the error report identifying a set of unique errors associated with the set of error logs, where a same error in two or more error logs of the set of error logs includes a single unique error.

In some examples, to support generating the error report, the error report manager 635 may be configured as or otherwise support a means for generating the error report indicating a quantity of instances each unique error occurred in the set of error logs.

In some examples, the error similarity manager 645 may be configured as or otherwise support a means for identifying that two or more natural language error strings correspond to a same error based on the two or more natural language error strings having a character similarity satisfying a threshold.

In some examples, to support generating the error report, the periodic error report manager 650 may be configured as or otherwise support a means for generating the error report based on a duration since generation of a previous error report satisfying a threshold.

In some examples, the periodic error report manager 650 may be configured as or otherwise support a means for receiving, from a user interface view associated with an administrator of the DMS, an indication of the threshold.

In some examples, to support generating the error report, the periodic error report manager 650 may be configured as or otherwise support a means for generating the error report based on additional natural language error strings and additional corresponding metadata associated with additional sets of error logs stored in the second database since the previous error report, where sets of error logs are periodically received, and where NLP is periodically performed on the sets of error logs that are periodically received to generate sets of natural language error strings and corresponding metadata for the set of error logs that are periodically received, and where the generated sets of natural language error strings and corresponding metadata for the set of error logs that are periodically received are periodically stored in the second database.

In some examples, to support generating the error report, the error threshold manager 655 may be configured as or otherwise support a means for generating the error report based on a quantity of instances of a same error satisfying a threshold.

In some examples, the error threshold manager 655 may be configured as or otherwise support a means for receiving, from a user interface view associated with an administrator of the DMS, an indication of the threshold.

In some examples, to support generating the error report, the error alert manager 660 may be configured as or otherwise support a means for generating the error report based on the corresponding metadata satisfying a triggering condition, the triggering condition including an account identifier, an object identifier, a job type, or a customer identifier.

In some examples, to support performing the NLP on the set of error logs, the NLP manager 630 may be configured as or otherwise support a means for removing punctuation in error strings of the set of error logs, removing stop words in the error strings of the set of error logs, removing numerals in error strings of the set of error logs, removing uniform resource locators in the error strings of the set of error logs, removing geographic information in the error strings of the set of error logs, performing tokenization on the error strings of the set of error logs, performing stemming on the error strings of the set of error logs, performing lemmatization on the error strings of the set of error logs, or a combination thereof.

In some examples, the stop word manager 670 may be configured as or otherwise support a means for receiving, from a user interface view associated with an administrator of the DMS, an indication of the stop words.

In some examples, the error report presentation manager 665 may be configured as or otherwise support a means for presenting, at user interface view associated with an administrator of the DMS, the error report.

In some examples, the first database and the second database include a same database.

In some examples, the first database is different from the second database.

FIG. 7 illustrates a block diagram 700 of a system 705 that supports error deduplication and reporting for a DMS based on NLP of error messages in accordance with aspects of the present disclosure. The system 705 may be an example of or include the components of a system 505 as described herein. The system 705 may include components for data management, including components such as a DMS 720, an input information 710, an output information 715, a network interface 725, a memory 730, a processor 735, and a storage 740. These components may be in electronic communication or otherwise coupled with each other (e.g., operatively, communicatively, functionally, electronically, electrically: via one or more buses, communications links, communications interfaces, or any combination thereof). Additionally, the components of the system 705 may include corresponding physical components or may be implemented as corresponding virtual components (e.g., components of one or more virtual machines). In some examples, the system 705 may be an example of aspects of one or more components described with reference to FIG. 1, such as a DMS 110.

The network interface 725 may enable the system 705 to exchange information (e.g., input information 710, output information 715, or both) with other systems or devices (not shown). For example, the network interface 725 may enable the system 705 to connect to a network (e.g., a network 120 as described herein). The network interface 725 may include one or more wireless network interfaces, one or more wired network interfaces, or any combination thereof. In some examples, the network interface 725 may be an example of may be an example of aspects of one or more components described with reference to FIG. 1, such as one or more network interfaces 165.

Memory 730 may include RAM, ROM, or both. The memory 730 may store computer-readable, computer-executable software including instructions that, when executed, cause the processor 735 to perform various functions described herein. In some cases, the memory 730 may contain, among other things, a basic input/output system (BIOS), which may control basic hardware or software operation such as the interaction with peripheral components or devices. In some cases, the memory 730 may be an example of aspects of one or more components described with reference to FIG. 1, such as one or more memories 175.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in a memory 730 to perform various functions (e.g., functions or tasks supporting error deduplication and reporting for a DMS based on NLP of error messages). Though a single processor 735 is depicted in the example of FIG. 7, it is to be understood that the system 705 may include any quantity of one or more of processors 735 and that a group of processors 735 may collectively perform one or more functions ascribed herein to a processor, such as the processor 735. In some cases, the processor 735 may be an example of aspects of one or more components described with reference to FIG. 1, such as one or more processors 170.

Storage 740 may be configured to store data that is generated, processed, stored, or otherwise used by the system 705. In some cases, the storage 740 may include one or more HDDs, one or more SDDs, or both. In some examples, the storage 740 may be an example of a single database, a distributed database, multiple distributed databases, a data store, a data lake, or an emergency backup database. In some examples, the storage 740 may be an example of one or more components described with reference to FIG. 1, such as one or more network disks 180.

For example, the DMS 720 may be configured as or otherwise support a means for receiving, from a first database, a set of error logs associated with a DMS. The DMS 720 may be configured as or otherwise support a means for performing NLP on the set of error logs to generate a set of natural language error strings and corresponding metadata for the set of error logs. The DMS 720 may be configured as or otherwise support a means for storing the set of natural language error strings and corresponding metadata for the set of error logs in a second database. The DMS 720 may be configured as or otherwise support a means for generating an error report based on the set of natural language error strings and corresponding metadata stored in the second database, where the error report identifies one or more same errors associated with the set of error logs based on the set of natural language error strings.

By including or configuring the DMS 720 in accordance with examples as described herein, the system 705 may support techniques for error deduplication and reporting for the DMS based on NLP of error messages, which may provide one or more benefits such as, for example, improved reliability, more efficient utilization of computing resources, network resources or both, improved scalability, or improved security, among other possibilities.

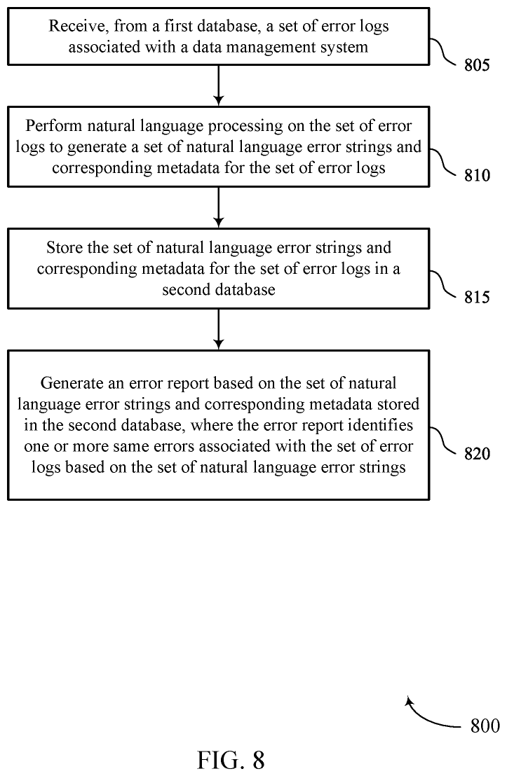

FIG. 8 illustrates a flowchart showing a method 800 that supports error deduplication and reporting for a DMS based on NLP of error messages in accordance with aspects of the present disclosure. The operations of the method 800 may be implemented by a DMS or its components as described herein. For example, the operations of the method 800 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 805, the method may include receiving, from a first database, a set of error logs associated with a DMS. The operations of 805 may be performed in accordance with examples as disclosed herein. In some examples, aspects of the operations of 805 may be performed by an error log manager 625 as described with reference to FIG. 6.

At 810, the method may include performing NLP on the set of error logs to generate a set of natural language error strings and corresponding metadata for the set of error logs. The operations of 810 may be performed in accordance with examples as disclosed herein. In some examples, aspects of the operations of 810 may be performed by an NLP manager 630 as described with reference to FIG. 6.

At 815, the method may include storing the set of natural language error strings and corresponding metadata for the set of error logs in a second database. The operations of 815 may be performed in accordance with examples as disclosed herein. In some examples, aspects of the operations of 815 may be performed by an NLP manager 630 as described with reference to FIG. 6.

At 820, the method may include generating an error report based on the set of natural language error strings and corresponding metadata stored in the second database, where the error report identifies one or more same errors associated with the set of error logs based on the set of natural language error strings. The operations of 820 may be performed in accordance with examples as disclosed herein. In some examples, aspects of the operations of 820 may be performed by an error report manager 635 as described with reference to FIG. 6.

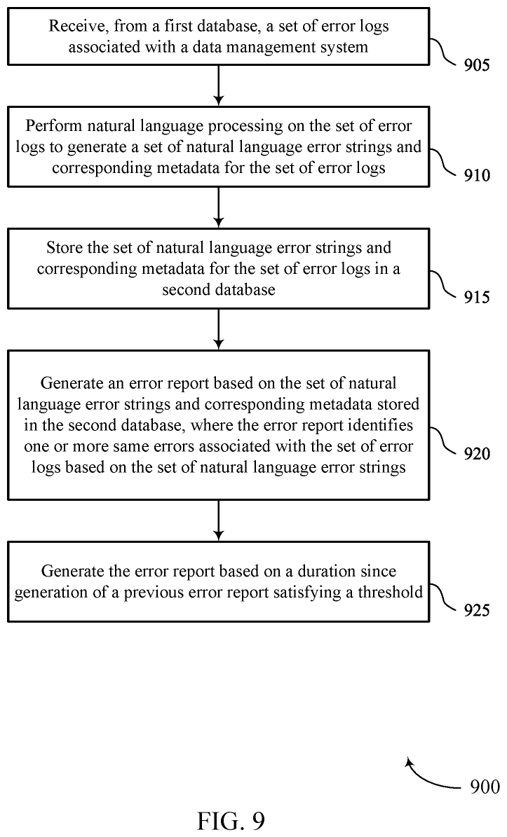

FIG. 9 illustrates a flowchart showing a method 900 that supports error deduplication and reporting for a DMS based on NLP of error messages in accordance with aspects of the present disclosure. The operations of the method 900 may be implemented by a DMS or its components as described herein. For example, the operations of the method 900 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 905, the method may include receiving, from a first database, a set of error logs associated with a DMS. The operations of 905 may be performed in accordance with examples as disclosed herein. In some examples, aspects of the operations of 905 may be performed by an error log manager 625 as described with reference to FIG. 6.

At 910, the method may include performing NLP on the set of error logs to generate a set of natural language error strings and corresponding metadata for the set of error logs. The operations of 910 may be performed in accordance with examples as disclosed herein. In some examples, aspects of the operations of 910 may be performed by an NLP manager 630 as described with reference to FIG. 6.

At 915, the method may include storing the set of natural language error strings and corresponding metadata for the set of error logs in a second database. The operations of 915 may be performed in accordance with examples as disclosed herein. In some examples, aspects of the operations of 915 may be performed by an NLP manager 630 as described with reference to FIG. 6.

At 920, the method may include generating an error report based on the set of natural language error strings and corresponding metadata stored in the second database, where the error report identifies one or more same errors associated with the set of error logs based on the set of natural language error strings. The operations of 920 may be performed in accordance with examples as disclosed herein. In some examples, aspects of the operations of 920 may be performed by an error report manager 635 as described with reference to FIG. 6.

At 925, the method may include generating the error report based on a duration since generation of a previous error report satisfying a threshold. The operations of 925 may be performed in accordance with examples as disclosed herein. In some examples, aspects of the operations of 925 may be performed by a periodic error report manager 650 as described with reference to FIG. 6.

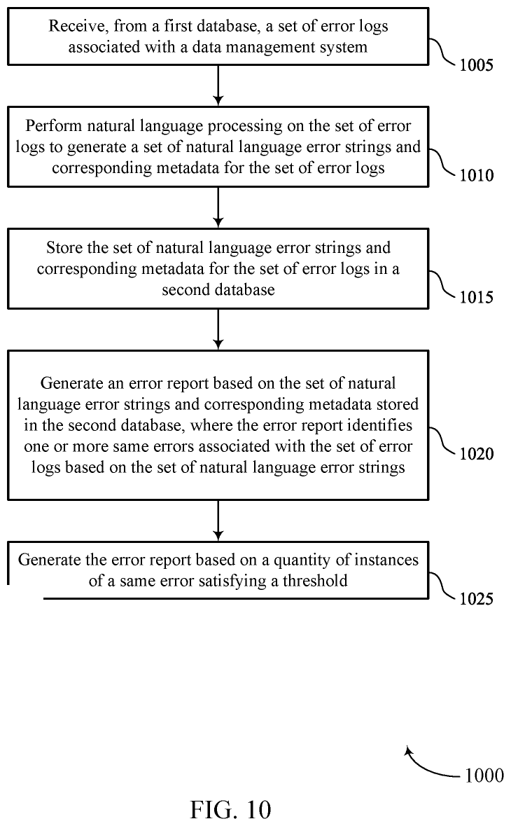

FIG. 10 illustrates a flowchart showing a method 1000 that supports error deduplication and reporting for a DMS based on NLP of error messages in accordance with aspects of the present disclosure. The operations of the method 1000 may be implemented by a DMS or its components as described herein. For example, the operations of the method 1000 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 1005, the method may include receiving, from a first database, a set of error logs associated with a DMS. The operations of 1005 may be performed in accordance with examples as disclosed herein. In some examples, aspects of the operations of 1005 may be performed by an error log manager 625 as described with reference to FIG. 6.

At 1010, the method may include performing NLP on the set of error logs to generate a set of natural language error strings and corresponding metadata for the set of error logs. The operations of 1010 may be performed in accordance with examples as disclosed herein. In some examples, aspects of the operations of 1010 may be performed by an NLP manager 630 as described with reference to FIG. 6.

At 1015, the method may include storing the set of natural language error strings and corresponding metadata for the set of error logs in a second database. The operations of 1015 may be performed in accordance with examples as disclosed herein. In some examples, aspects of the operations of 1015 may be performed by an NLP manager 630 as described with reference to FIG. 6.

At 1020, the method may include generating an error report based on the set of natural language error strings and corresponding metadata stored in the second database, where the error report identifies one or more same errors associated with the set of error logs based on the set of natural language error strings. The operations of 1020 may be performed in accordance with examples as disclosed herein. In some examples, aspects of the operations of 1020 may be performed by an error report manager 635 as described with reference to FIG. 6.

At 1025, the method may include generating the error report based on a quantity of instances of a same error satisfying a threshold. The operations of 1025 may be performed in accordance with examples as disclosed herein. In some examples, aspects of the operations of 1025 may be performed by an error threshold manager 655 as described with reference to FIG. 6.

A method is described. The method may include receiving, from a first database, a set of error logs associated with a DMS, performing NLP on the set of error logs to generate a set of natural language error strings and corresponding metadata for the set of error logs, storing the set of natural language error strings and corresponding metadata for the set of error logs in a second database, and generating an error report based on the set of natural language error strings and corresponding metadata stored in the second database, where the error report identifies one or more same errors associated with the set of error logs based on the set of natural language error strings.

An apparatus is described. The apparatus may include a processor, memory coupled with the processor, and instructions stored in the memory. The instructions may be executable by the processor to cause the apparatus to receive, from a first database, a set of error logs associated with a DMS, perform NLP on the set of error logs to generate a set of natural language error strings and corresponding metadata for the set of error logs, store the set of natural language error strings and corresponding metadata for the set of error logs in a second database, and generate an error report based on the set of natural language error strings and corresponding metadata stored in the second database, where the error report identifies one or more same errors associated with the set of error logs based on the set of natural language error strings.

Another apparatus is described. The apparatus may include means for receiving, from a first database, a set of error logs associated with a DMS, means for performing NLP on the set of error logs to generate a set of natural language error strings and corresponding metadata for the set of error logs, means for storing the set of natural language error strings and corresponding metadata for the set of error logs in a second database, and means for generating an error report based on the set of natural language error strings and corresponding metadata stored in the second database, where the error report identifies one or more same errors associated with the set of error logs based on the set of natural language error strings.

A non-transitory computer-readable medium storing code is described. The code may include instructions executable by a processor to receive, from a first database, a set of error logs associated with a DMS, perform NLP on the set of error logs to generate a set of natural language error strings and corresponding metadata for the set of error logs, store the set of natural language error strings and corresponding metadata for the set of error logs in a second database, and generate an error report based on the set of natural language error strings and corresponding metadata stored in the second database, where the error report identifies one or more same errors associated with the set of error logs based on the set of natural language error strings.

In some examples of the method, apparatuses, and non-transitory computer-readable medium described herein, generating the error report may include operations, features, means, or instructions for generating the error report identifying a set of unique errors associated with the set of error logs, where a same error in two or more error logs of the set of error logs includes a single unique error.

In some examples of the method, apparatuses, and non-transitory computer-readable medium described herein, generating the error report may include operations, features, means, or instructions for generating the error report indicating a quantity of instances each unique error occurred in the set of error logs.

Some examples of the method, apparatuses, and non-transitory computer-readable medium described herein may further include operations, features, means, or instructions for identifying that two or more natural language error strings correspond to a same error based on the two or more natural language error strings having a character similarity satisfying a threshold.

In some examples of the method, apparatuses, and non-transitory computer-readable medium described herein, generating the error report may include operations, features, means, or instructions for generating the error report based on a duration since generation of a previous error report satisfying a threshold.

Some examples of the method, apparatuses, and non-transitory computer-readable medium described herein may further include operations, features, means, or instructions for receiving, from a user interface view associated with an administrator of the DMS, an indication of the threshold.

In some examples of the method, apparatuses, and non-transitory computer-readable medium described herein, generating the error report may include operations, features, means, or instructions for generating the error report based on additional natural language error strings and additional corresponding metadata associated with additional sets of error logs stored in the second database since the previous error report, where sets of error logs may be periodically received, and where NLP may be periodically performed on the sets of error logs that may be periodically received to generate sets of natural language error strings and corresponding metadata for the set of error logs that may be periodically received, and where the generated sets of natural language error strings and corresponding metadata for the set of error logs that may be periodically received may be periodically stored in the second database.

In some examples of the method, apparatuses, and non-transitory computer-readable medium described herein, generating the error report may include operations, features, means, or instructions for generating the error report based on a quantity of instances of a same error satisfying a threshold.

Some examples of the method, apparatuses, and non-transitory computer-readable medium described herein may further include operations, features, means, or instructions for receiving, from a user interface view associated with an administrator of the DMS, an indication of the threshold.

In some examples of the method, apparatuses, and non-transitory computer-readable medium described herein, generating the error report may include operations, features, means, or instructions for generating the error report based on the corresponding metadata satisfying a triggering condition, the triggering condition including an account identifier, an object identifier, a job type, or a customer identifier.

In some examples of the method, apparatuses, and non-transitory computer-readable medium described herein, performing the NLP on the set of error logs may include operations, features, means, or instructions for removing punctuation in error strings of the set of error logs, removing stop words in the error strings of the set of error logs, removing numerals in error strings of the set of error logs, removing uniform resource locators in the error strings of the set of error logs, removing geographic information in the error strings of the set of error logs, performing tokenization on the error strings of the set of error logs, performing stemming on the error strings of the set of error logs, performing lemmatization on the error strings of the set of error logs, or a combination thereof.

Some examples of the method, apparatuses, and non-transitory computer-readable medium described herein may further include operations, features, means, or instructions for receiving, from a user interface view associated with an administrator of the DMS, an indication of the stop words.

Some examples of the method, apparatuses, and non-transitory computer-readable medium described herein may further include operations, features, means, or instructions for presenting, at user interface view associated with an administrator of the DMS, the error report.

In some examples of the method, apparatuses, and non-transitory computer-readable medium described herein, the first database and the second database include a same database.

In some examples of the method, apparatuses, and non-transitory computer-readable medium described herein, the first database may be different from the second database.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
receiving, from a first database, a set of error logs associated with a data management system;
performing natural language processing on the set of error logs to generate a set of natural language error strings and corresponding metadata for the set of error logs;
storing the set of natural language error strings and corresponding metadata for the set of error logs in a second database; and
generating an error report based on the set of natural language error strings and corresponding metadata stored in the second database, wherein the error report identifies one or more same errors associated with the set of error logs based on the set of natural language error strings.

2. The method of claim 1, wherein generating the error report comprises:
generating the error report identifying a set of unique errors associated with the set of error logs, wherein a same error in two or more error logs of the set of error logs comprises a single unique error.

3. The method of claim 2, wherein generating the error report comprises:
generating the error report indicating a quantity of instances each unique error occurred in the set of error logs.

4. The method of claim 1, further comprising:
identifying that two or more natural language error strings correspond to a same error based on the two or more natural language error strings having a character similarity satisfying a threshold.

5. The method of claim 1, wherein generating the error report comprises:
generating the error report based on a duration since generation of a previous error report satisfying a threshold.

6. The method of claim 5, further comprising:
receiving, from a user interface view associated with an administrator of the data management system, an indication of the threshold.

7. The method of claim 5, wherein generating the error report comprises:
generating the error report based on additional natural language error strings and additional corresponding metadata associated with additional sets of error logs stored in the second database since the previous error report, wherein sets of error logs are periodically received, and wherein natural language processing is periodically performed on the sets of error logs that are periodically received to generate sets of natural language error strings and corresponding metadata for the set of error logs that are periodically received, and wherein the generated sets of natural language error strings and corresponding metadata for the set of error logs that are periodically received are periodically stored in the second database.

8. The method of claim 1, wherein generating the error report comprises:
generating the error report based on a quantity of instances of a same error satisfying a threshold.

9. The method of claim 8, further comprising:
receiving, from a user interface view associated with an administrator of the data management system, an indication of the threshold.

10. The method of claim 1, wherein generating the error report comprises:
generating the error report based on the corresponding metadata satisfying a triggering condition, the triggering condition comprising an account identifier, an object identifier, a job type, or a customer identifier.

11. The method of claim 1, wherein performing the natural language processing on the set of error logs comprises:
removing punctuation in error strings of the set of error logs, removing stop words in the error strings of the set of error logs, removing numerals in error strings of the set of error logs, removing uniform resource locators in the error strings of the set of error logs, removing geographic information in the error strings of the set of error logs, performing tokenization on the error strings of the set of error logs, performing stemming on the error strings of the set of error logs, performing lemmatization on the error strings of the set of error logs, or a combination thereof.

12. The method of claim 11, further comprising:
receiving, from a user interface view associated with an administrator of the data management system, an indication of the stop words.

13. The method of claim 1, further comprising:
presenting, at user interface view associated with an administrator of the data management system, the error report.

14. The method of claim 1, wherein the first database and the second database comprise a same database.

15. The method of claim 1, wherein the first database is different from the second database.

16. An apparatus, comprising:
a processor;
memory coupled with the processor; and
instructions stored in the memory and executable by the processor to cause the apparatus to:
receive, from a first database, a set of error logs associated with a data management system;
perform natural language processing on the set of error logs to generate a set of natural language error strings and corresponding metadata for the set of error logs;
store the set of natural language error strings and corresponding metadata for the set of error logs in a second database; and
generate an error report based on the set of natural language error strings and corresponding metadata stored in the second database, wherein the error report identifies one or more same errors associated with the set of error logs based on the set of natural language error strings.

17. The apparatus of claim 16, wherein the instructions to generate the error report are executable by the processor to cause the apparatus to:
generate the error report identifying a set of unique errors associated with the set of error logs, wherein a same error in two or more error logs of the set of error logs comprises a single unique error.

18. The apparatus of claim 17, wherein the instructions to generate the error report are executable by the processor to cause the apparatus to:
generate the error report indicating a quantity of instances each unique error occurred in the set of error logs.

19. The apparatus of claim 16, wherein the instructions are further executable by the processor to cause the apparatus to:
identify that two or more natural language error strings correspond to a same error based on the two or more natural language error strings having a character similarity satisfying a threshold.

20. A non-transitory computer-readable medium storing code, the code comprising instructions executable by a processor to:
receive, from a first database, a set of error logs associated with a data management system;
perform natural language processing on the set of error logs to generate a set of natural language error strings and corresponding metadata for the set of error logs;
store the set of natural language error strings and corresponding metadata for the set of error logs in a second database; and
generate an error report based on the set of natural language error strings and corresponding metadata stored in the second database, wherein the error report identifies one or more same errors associated with the set of error logs based on the set of natural language error strings.
